(19) United States
(12) Patent Application Publication
(10) Pub. No.: US 2015/0258851 A1
(43) Pub. Date: Sep. 17, 2015

(54) CASTER SUSPENSION SYSTEM

(71) Applicant: SUNRISE MEDICAL (US), LLC, Fresno, CA (US)

(72) Inventor: Harlan H. Hart, Madera, CA (US)

(73) Assignee: SUNRISE MEDICAL (US), LLC, Fresno, CA (US)

(21) Appl. No.: 14/658,920

(22) Filed: Mar. 16, 2015

Related U.S. Application Data
(60) Provisional application No. 61/953,397, filed on Mar. 14, 2014.

(51) Int. Cl. B60B 33/04; A61G 5/10; B60G 3/20

(52) U.S. Cl. CPC B60B 33/045; B60G 3/20; A61G 5/10; A61G 2005/1078

(57) ABSTRACT

A caster having a four bar suspension configured for use with a wheelchair includes a caster wheel supported for rotation by a caster fork. The caster fork forms one link of the four bar suspension and is pivotally connected to an upper link. The upper link is pivotally mounted to and generally coaxially disposed about a caster stem housing. A lower link pivotally mounted to the caster stem housing and the caster fork. A resilient member is disposed between the caster stem housing and the lower link.

### CROSS-REFERENCE TO RELATED APPLICATIONS

This application claims the benefit of U.S. Provisional Application No. 61/953,397, filed Mar. 14, 2014, the disclosure of which is incorporated herein by reference.

### BACKGROUND OF THE INVENTION

This invention relates in general to caster suspension systems. In particular, this invention relates to a suspension for wheelchair caster wheel assemblies, applicable to both front and rear caster assemblies.

Caster assemblies for wheelchairs provide steering and stability functions as a user navigates terrain. Some caster assemblies are provided with suspension systems to improve ride comfort and handling as the wheelchair encounters obstacles. Some caster suspensions provide a resilient member that acts on the caster pivot stem, such as is provided on the Colours brand, Boing manual wheelchair. While providing a compact spring arrangement relative to a wheelchair's longitudinal axis, the caster stem must be sufficiently tall to permit the desired amount of suspension travel. This typically necessitates providing enough height clearance to accommodate the mounting arrangement and component movements, making packaging more difficult.

Another caster suspension is the Frog Leg suspension, produced by Frog Legs, Inc. and disclosed in U.S. Pat. No. 6,149,169 to Chelgren. The Frog Leg suspension utilizes a resilient member, in to form of a rubber cylinder that is loaded in compression and positioned in-line between a caster stem and a caster fork. This system functions similarly to automotive knee-action suspension systems and are generally compact relative to the wheelchair's longitudinal axis. The rubber resilient member, however, is loaded in compression which causes the rubber to stiffen as the loading increases. Thus, the spring reaction forces increase significantly and non-linearly as the rubber is loaded. Additionally, these knee-action systems, like their automotive counterparts of the 1930's are prone to accelerated wear if not maintained.

Another caster suspension system, shown in U.S. Pat. No. 7,264,272 to Mulhern et al., utilizes a resilient spring arrangement that is mounted to a parallelogram linkage. The parallelogram linkage is configured as an anti-tip mechanism that extends generally forwardly from the wheelchair frame and provides the caster assembly at the outermost end of the linkage. The resilient member, which forms the caster suspension structure, is connected between the furthest end of the linkage and the frame, between the linkage arms, or as torsional resilient members at the pivot points. This arrangement provides a longer longitudinal wheelbase or overall wheelchair length which increases the difficulties associated with maneuvering in tight spaces. Thus for the foregoing reasons, it would be desirable to provide a caster assembly having a compact suspension system.

### SUMMARY OF THE INVENTION

This invention relates to a wheelchair caster assembly having a caster wheel and a caster suspension. The caster suspension includes a caster fork that supports the caster wheel for rotation. An upper link is pivotally mounted to the caster fork and is also pivotally mounted to and generally coaxially disposed about a caster stem housing. A lower link is pivotally mounted to the caster stem housing and the caster fork. A resilient member disposed between the caster stem housing and the lower link.

In another aspect of the invention, a wheelchair includes a frame connected to a caster stem. The caster stem supports a caster stem housing for rotation relative to the frame. A caster four-bar suspension provides jounce and rebound movement of a caster wheel relative to the frame. A caster fork supports the caster wheel for rotation. An upper end of the caster fork forms a first link of the suspension. An upper link is pivotally mounted to the caster fork and forms a second link of the suspension. The upper link is further pivotally mounted to and generally coaxially disposed about the caster stem housing. The caster stem housing forming a third link of the suspension. A lower link is pivotally mounted to the caster stem housing and the caster fork. The lower link forming a fourth link of the suspension. A resilient member is disposed between the caster stem housing and the lower link.

Various aspects of this invention will become apparent to those skilled in the art from the following detailed description of the preferred embodiment, when read in light of the accompanying drawings.

### BRIEF DESCRIPTION OF THE DRAWINGS

FIG. 1A is a side view of a portion of a wheelchair and a caster assembly having a suspension system in accordance with the invention.

FIG. 1B is an enlarged perspective view of the caster assembly of FIG. 1A.

FIG. 2 is an exploded perspective view of the caster assembly of FIG. 1.

FIG. 3A is an enlarged, exploded, side view of a four-bar linkage portion of the suspension system of FIG. 2.

FIG. 3B is a cross sectional, side view of caster assembly of FIG. 1.

FIG. 4 is a schematic illustration of the deflected and unloaded positions of the four bar linkage arrangement of the caster suspension of FIG. 1.

### DETAILED DESCRIPTION OF THE PREFERRED EMBODIMENT

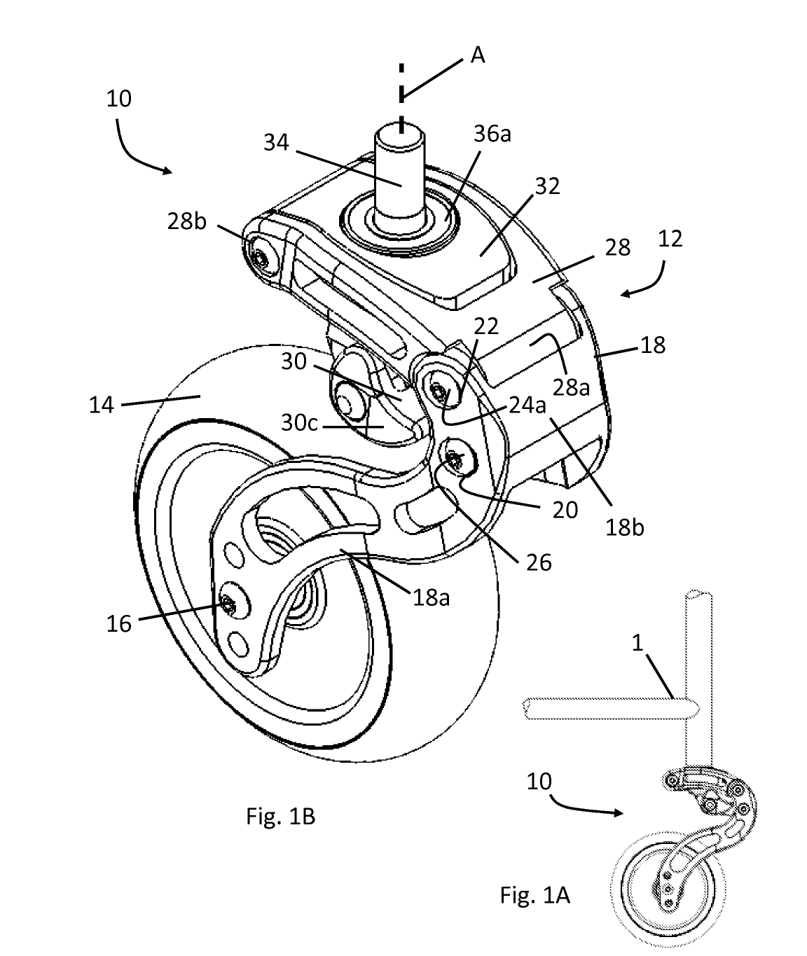

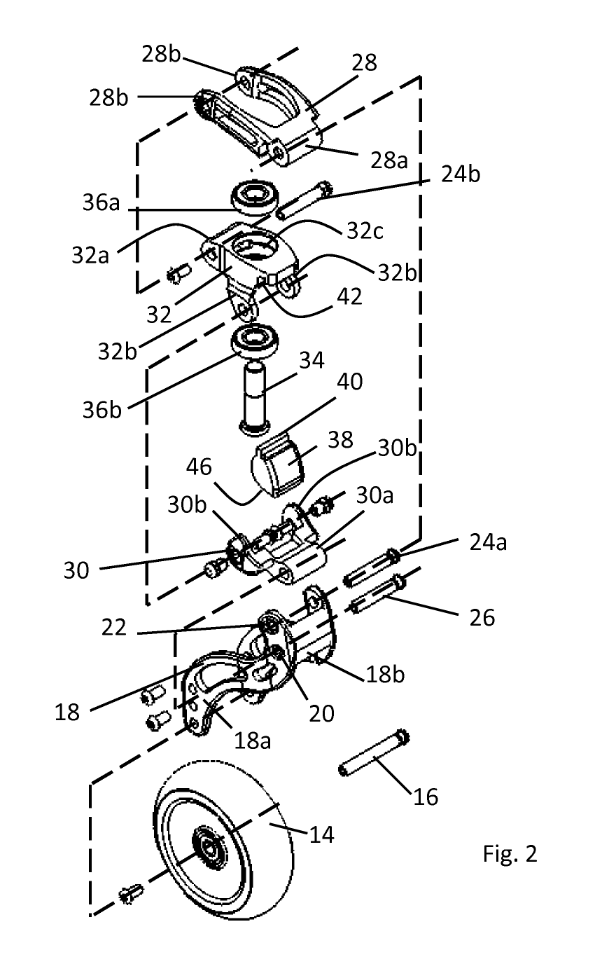

Referring now to the drawings, there is illustrated in FIGS. 1A and 1B a wheelchair 1 supported by a caster assembly, shown generally at 10, having a suspension system, shown generally at 12. The wheelchair 1 may be a manual or powered wheelchair. The caster assembly includes a caster wheel 14 supported for rotation on a caster axle 16 relative to a caster fork 18. The caster fork 18 is illustrated having a lower end 18a and an upper end 18b. The caster fork lower end is illustrated as two spaced-apart, curve-shaped plates that define a space to accommodate the caster wheel 14. The lower end 18a may have any shape that supports the caster wheel 14 for rotation. The two plates of the lower end 18a are connected together at the upper end 18b by one or more webbing structures extending therebetween. The caster fork 18 may be formed from a single piece, hollow or solid, or may be constructed from several components. The caster axle 16 connects the caster wheel 14 to the lower end 18a of the caster fork 18. As shown in FIG. 1, the caster fork 18 includes a plurality of mounting bores that permit the caster wheel 14 to be spaced in one of a plurality of different height positions. At the upper end 18b of the caster fork, two bores 20 and 22 are arranged in a spaced apart orientation and having axes that are generally parallel to each other and perpendicular to a caster stem axis, A. The section of the caster fork that extends between the upper bores, illustrated as the upper end 18b, forms a caster fork link arm that is part of the coaxial caster suspension parallelogram or 4-bar linkage system 12. The upper caster fork bores 20 and 22 permit a first upper link pivot axle 24a and a lower link pivot axle 26 to pass through.

An upper link 28 is pivotally attached at a first end 28a, by way of the first upper link pivot axle 24a, to one of the upper end bores of the caster fork, shown as the uppermost bore 22. A lower link 30 is pivotally attached at a first end 30a, by way of the lower link pivot axle 26, to the lower, upper end bore 20 of the caster fork 18. The upper link 28 is pivotally attached to an upper mounting point 32a of a caster stem housing 32 at a second end 28b of the upper link 28 by a second upper link pivot axle 24b. The caster stem housing 32 includes a pair of spaced apart lower mounting points 32b, shown as mounting ears that extend toward the caster wheel 14 and having coaxially aligned bores. The mounting ears 32b may alternatively be configured as a solid mounting structure extending across the width of the caster stem housing 32, if desired. The lower mounting points 32b support a second end 30b of the lower link 30 for pivotal movement relative to the caster stem housing 32. The caster stem housing 32, and particularly the section between the spaced-apart upper 32a and lower mounting points 32b forms a ground or grounding link of the coaxial 4-bar linkage. The upper and lower links 28 and 30, respectively, complete the 4-bar structure of the caster suspension system 12.

The caster stem housing 32 supports a caster stem 34 which connects to the wheelchair framel. The caster stem 34 is rotatably supported relative to the caster stem housing 32 by two bearing elements, an upper support bearing 36a and a lower support bearing 36b, that are positioned within a pivot bearing bore 32c formed through the caster housing 32. The bearing elements 36a and 36b permit the caster wheel 14 and caster suspension 12 to swivel relative to the wheelchair frame 1 during steering events.

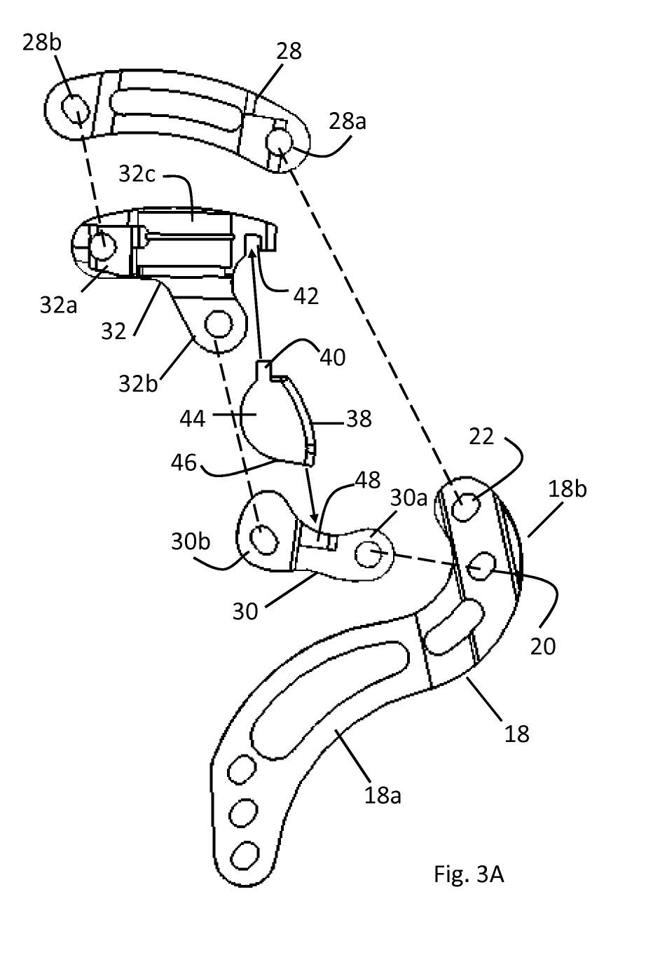

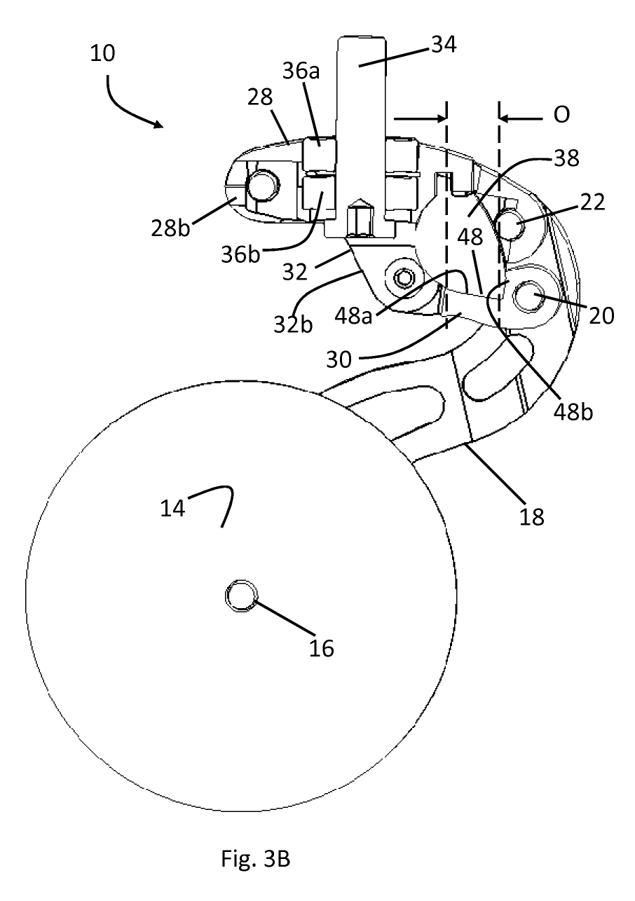

A resilient member 38 is connected between the stem housing and the lower link. In one embodiment, the resilient member 38 is configured as a rubber spring element that is loaded in shear and may also include a bending load component. Alternatively, the rubber member 38 may be substantially loaded in compression. In the illustrated embodiment, the shear loading of the rubber spring provides a generally constant spring rate as the rubber deflects through the range of suspension articulation. In alternative embodiments, the resilient member 38 may be configured as a coil spring, diaphragm spring, hair-pin spring, or dampened shock absorber/suspension spring to provide the desired suspension load/deflection characteristics. In the illustrated embodiment, the resilient member 38 includes a mounting tab 40 that engages a corresponding slot 42 formed in the caster stem housing 32. The resilient member 38 is illustrated as having a general tear-drop or lemon shaped body portion 44. It should be understood that any other shape of resilient member 38 may be used. A base 46 of the body portion 44 mounts in a correspondingly shaped cavity or mounting pocket 48 formed in the center of the lower link 30. The mounting pocket 48 defines a floor 48a and a reaction wall 48b that contain the base 46 of the resilient member 38. As is shown in FIGS. 3A and 3B, the slot 42 is offset from the intersection of the floor 48a and the reaction wall 48b. This offset, O, permits the resilient member 38 to be proportionally loaded in shear thus permitting a more generally constant support load through the range of motion of the suspension system 12. The offset O may be adjusted to alter the amount of shear loading, orient the resilient member in compression, or accommodate an alternate configuration of resilient member. As mentioned above, alternative shapes of resilient members may be used to vary the loading reactions of the suspension.

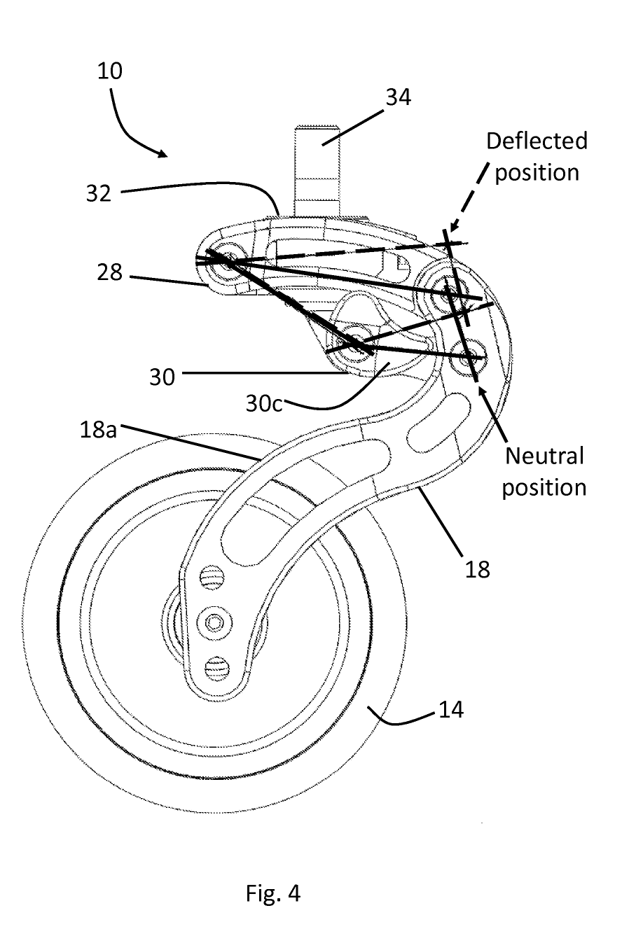

As shown in FIG. 4, the orientation of the links and pivots of the four bar suspensions system 12 is shown by the solid lines in the neutral position. This position is generally midway between the jounce and rebound positions of the suspension. In operation, as the caster wheel 14 is deflected upwardly toward the wheelchair frame 1, such as when encountering a raised obstacle, the lower link first end 30a is moved generally upwardly toward the wheelchair frame 1 and rotates about the lower link first pivot axle 26. The first end 28a of the upper link 28 is also moved generally upwardly. The upper and lower links move in a generally parallel or coordinated movement, and the resilient member is loaded between the caster stem housing and the lower link. The dashed line represents the link and pivot orientations in the jounce or compressed position of the suspension. In a full jounce position of the suspension system 12, i.e., a fully compressed articulation, a stop block 30c of the lower link 30 contacts a corresponding surface of the caster fork 18 and acts as a positive stop for jounce suspension movement. As can be understood by the kinematic reactions of the linkages, the resilient member 38 is loaded between the slot 42 and the floor 48a and reaction wall 48b in at least a partial shearing load orientation. This shearing or bending load applies a counteracting force on the lower link 30 to bias the caster wheel 14 back to its original position. The caster stem housing 32 acts as a grounding link since any pivotal movement of the stem 34 and housing 32 is resisted by the wheelchair frame. Thus, the caster stem housing is configured to swivel along a plane generally perpendicular to the wheelchair frame and constrained from pivoting along a plane generally parallel relative to the wheelchair frame.

The movement of the upper and lower links 30 and 32 in a generally parallel or as a shifting trapezoid movement, shown in FIG. 4, minimizes the rearward deflection of the caster wheel 14 as it articulates through its range of motion from a jounce to a static or neutral position and then to a rebound position. This reduces a diving sensation by minimizing or preventing a forward pitching motion of the wheelchair. As shown in the illustrated embodiment, the open design of the caster fork and linkages also permits easier, open access to the caster stem from below without necessitating disassembly of the caster fork. The coaxial orientation of the upper link about the caster stem housing 32 also permits a compact suspension layout to minimize height and length space requirements.

The principle and mode of operation of this invention have been explained and illustrated in its preferred embodiment. However, it must be understood that this invention may be practiced otherwise than as specifically explained and illustrated without departing from its spirit or scope.

What is claimed is:

1. A wheelchair caster assembly comprising:
a caster wheel; and
a caster suspension comprising:
a caster fork supporting the caster wheel for rotation;
an upper link pivotally mounted to the caster fork, the upper link further pivotally mounted to and generally coaxially disposed about a caster stem housing;
a lower link pivotally mounted to the caster stem housing and the caster fork; and
a resilient member disposed between the caster stem housing and the lower link.

2. The wheelchair caster assembly of claim 1 wherein a caster stem is supported by the caster stem housing, the caster stem being configured to attach the caster wheel to a wheelchair frame member for relative swiveling movement.

3. The wheelchair caster assembly of claim 1 wherein the caster stem housing includes a slot that engages a first portion of the resilient member and the lower link includes a pocket that receives a second portion of the resilient member.

4. The wheelchair caster assembly of claim 3 wherein the pocket includes a floor and a reaction wall that each bear against the resilient member.

5. The wheelchair caster assembly of claim 4 wherein the relative orientation of the slot to the pocket defines an offset, the offset defining a proportional shear loading of the resilient member during articulation through a range of motion of the caster suspension.

6. The wheelchair caster assembly of claim 3 wherein the resilient member includes a mounting tab that engages the slot of the caster stem housing.

7. The wheelchair caster assembly of claim 2 wherein the caster stem housing includes a bore that receives a bearing element, the bearing element supporting the caster stem.

8. The wheelchair caster assembly of claim 1 wherein the lower link includes a stop block configured to contact the caster fork at an end of travel position of the caster suspension.

9. The wheelchair caster assembly of claim 8 wherein the upper and lower links move in a generally parallel pattern during movement of the caster suspension, the upper link pivoting relative to the coaxially mounted caster stem housing.

10. The wheelchair caster assembly of claim 1 wherein the upper link, lower link, caster fork, and caster stem housing define a four bar linkage system caster suspension that has a shifting trapezoid movement during suspension articulation.

11. The wheelchair caster assembly of claim 10 wherein the resilient member is connected between the caster stem housing and the lower link, the caster stem housing forming a grounding link and the upper link pivoting coaxially about the caster stem housing during suspension articulation.

12. The wheelchair caster assembly of claim 11 wherein the connection between the resilient member and the caster stem housing is laterally offset from the connection between the resilient member and the lower link such that the resilient member is at least partially loaded in a shear in response to articulation of the caster fork.

13. The wheelchair caster assembly of claim 12 wherein the connection between the resilient member and the caster stem housing is defined by a slot engaging a mounting tab.

14. The wheelchair caster assembly of claim 13 wherein the resilient member seats within a pocket formed in the lower link, the pocket defining a reaction wall that further defines the offset and restrains the resilient member against the shear loading during articulation.

15. The wheelchair caster assembly of claim 1 wherein the caster stem is fixed to a wheelchair frame, the caster stem housing supporting a bearing element that permits swiveling movement of the caster wheel relative to the wheelchair frame.

16. A wheelchair caster assembly comprising:
a caster fork supporting a caster wheel for rotation;
an upper link pivotally mounted to the caster fork;
a caster stem housing pivotally mounted to and generally coaxially disposed within the upper link, the caster stem housing configured as a grounded member that is free to swivel along a first plane and constrained from pivotal movement along a second plane that is generally perpendicular to the first plane;
a lower link pivotally mounted to the caster stem housing and the caster fork; and
a resilient member disposed between the caster stem housing and the lower link.

17. The wheelchair caster assembly of claim 16 wherein the resilient member is directly connected to the caster stem housing and the lower link such that movement of the lower link deflects the resilient member against the caster stem housing.

18. A wheelchair comprising:
a frame connected to a caster stem, the caster stem supporting a caster stem housing for rotation relative to the frame; and
a caster four-bar suspension comprising:
a caster fork supporting a caster wheel for rotation, an upper end of the caster fork forming a first link of the suspension;
an upper link pivotally mounted to the caster fork, the upper link forming a second link of the suspension and further pivotally mounted to and generally coaxially disposed about the caster stem housing, the caster stem housing forming a third link of the suspension;
a lower link pivotally mounted to the caster stem housing and the caster fork, the lower link forming a fourth link of the suspension; and
a resilient member disposed between the caster stem housing and the lower link.

19. The wheelchair of claim 18 wherein the caster stem housing is a grounding link configured to swivel along a plane generally perpendicular to the frame and constrained from pivoting along a plane generally parallel relative to the frame.

20. The wheelchair of claim 19 wherein the caster stem housing includes a slot that engages a first portion of the resilient member and the lower link includes a pocket that receives a second portion of the resilient member.
